(19) United States
(12) Patent Application Publication
(10) Pub. No.: US 2017/0302420 A1
(43) Pub. Date: Oct. 19, 2017

(54) Method for Sending and Receiving Reference Signal, and Communication Node

(71) Applicant: ZTE CORPORATION, Shenzhen City, Guangdong Province (CN)

(72) Inventors: Zhaohua LU, Shenzhen (CN); Yijian CHEN, Shenzhen (CN); Yu Ngok LI, Shenzhen (CN); Guanghui YU, Shenzhen (CN); Jing ZHAO, Shenzhen (CN); Huahua XIAO, Shenzhen (CN); Xianming CHEN, Shenzhen (CN)

(21) Appl. No.: 15/506,258

(22) PCT Filed: Apr. 3, 2015
(86) PCT No.: PCT/CN2015/075863

§ 371 Date: Jul. 5, 2017

(30) Foreign Application Priority Data
Aug. 25, 2014 (CN) 201410422875.0

(51) Int. Cl. H04L 5/00; H04W 72/04; H04L 12/24; H04B 7/024; G06F 17/14; H04L 29/06

(52) U.S. Cl. CPC H04L 5/0048; H04W 72/0426; H04L 41/0823; H04B 7/024; G06F 17/141

(57) ABSTRACT

The present document relates to a method for sending and receiving a reference signal and a communication node. The method includes: a first communication node sending a first reference signal and a second reference signal to a second communication node, the first reference signal is different from the second reference signal. The solution achieves the effect that the second communication node acquires channel state quality through the second reference signal which is different from the first reference signal when the second communication node cannot successfully receive the first reference signal.

### TECHNICAL FIELD

This text relates to a wireless communication technology, in particular to a method for sending and receiving a reference signal and a communication node.

### BACKGROUND

The emergence of smart mobile terminals such as smart phones and tablet computers drives prosperous development of wireless communication network data application services, e.g., cloud computing, Internet of Things, mobile internet, mobile phone video calls, mobile phone video conferences, online games, online videos, online music, picture download, microblog and communities, and also drives large-scale increase of wireless communication network users, resulting in explosive increase of wireless data services. As predicted by authority organizations, wireless data services will increase by 500-1000 times in future 10 years and averagely will increase by 1.6-2 times every year, and this raises a very high requirement on the capacity of a wireless communication system.

There are various methods for improving wireless network capacity and they commonly include: (1) increasing spectrum bandwidth; (2) enhancing traffic offload; (3) improving network density; and (4) improving spectrum efficiency. In order to better apply these methods, a key link is how to acquire accurate channel state information through a reference signal. Reference Signal (RS) usually is also called as a pilot signal, which is a known signal provided by a sender to a receiver for channel measurement estimation.

A performance gain of a multi-antenna technology is highly dependent on the reference signal. The problems existing in the design of the reference signal of the current Long Term Evolution (LTE) system will be described by taking the multi-antenna technology. Similarly, other technologies also raise new requirements on the reference signal and thus are not repetitively described herein one by one.

The multi-antenna technology is involved from Single-User Multiple-Input Multiple-Output (SU-MIMO) to Multi-User Multiple-Input Multiple-Output (MU-MIMU) and then is developed to a Coordinated Multiple Points (COMP) transmission technology, and the development concept is from the improvement of stability and peak traffic of a single link to the improvement of overall system traffic. However, in the implementation of COMP, due to various difficulties (e.g., too excessive resource overhead caused by channel measurement and data exchange, and imbalance of multi-path power), the performance is caused to be not ideal and it is very difficult to achieve an expected effect.

Under this background, a communication technology based on Large Scale Antenna System (LASA) or Massive Multiple-Input Multiple-Output (Massive MIMO) is put forward, it is an expansion and extension of the MIMO technology, and the basic principle is to serve multiple users simultaneously by configuring numerous wireless arrays (from tens to thousands) on a base station side and utilizing a Space Division Multiple Address (SDMA) principle. Since large scale antenna arrays bring huge array gains and interference suppression gains, the overall spectrum efficiency of a cell and the spectrum efficiency of edge users are greatly improved.

The biggest problem met by a large scale antenna array communication system during actual application is the overhead problem of the reference signal. According to LTE related reference signal design concept, each antenna port needs to send a proprietary reference signal to allow a terminal to acquire channel state information of the corresponding antenna port. With the increase of the number of antenna ports, the overhead of the reference signal increases linearly, more and more system resources are occupied by the transmission of the reference signal, consequently the available resources of the system decrease and further the overall performance of the system is reduced. By taking the large scale antenna array communication system as an example, supposing that a base station includes 128 physical antennas, according to the LTE related pilot design mode, in a physical resource block (including 84 physical subcarriers), the system at least needs 12 physical subcarriers for sending reference signals on four antenna ports to allow a terminal to perform channel estimation, and so on. Totally 1128 antennas need 12*128/4=384 physical subcarriers, this far exceeds the size of a physical resource block. In other words, subcarriers are not enough even though all subcarrier resources are used for sending pilot signals.

In order to reduce the overhead of the reference signal, new reference signal design methods such as beam pilot based on precoding, and non-beam pilot based on a compressive sensing technology, are introduced. Different methods are applicable to different scenarios.

In a related reference signal sending method, if a terminal cannot successfully receive a reference signal, the terminal cannot acquire channel state quality.

### SUMMARY

In order to solve the above-mentioned problems, the embodiments of the present document provide a method for sending and receiving a reference signal and a communication node, such that a second communication node can acquire channel state quality through a second reference signal different from a first reference signal when the second communication node cannot successfully receive the first reference signal.

In order to achieve the above-mentioned purpose, the embodiment of the present document provides a method for sending a reference signal, including:

a first communication node sending a first reference signal and a second reference signal to a second communication node, herein the first reference signal is different from the second reference signal.

In an exemplary embodiment, the method further includes:

the first communication node receiving feedback information from the second communication node; and

the first communication node sending service data to the second communication node according to the received feedback information.

In an exemplary embodiment, the first communication node sending the service data to the second communication node according to the received feedback information includes:

the first communication node determining a mode for sending the service data to the second communication node according to generation mode information of the received feedback information from the second communication node,

herein the generation mode information includes information about that the feedback information is generated based on the first reference signal, or is generated based on the second reference signal or is generated based on the first reference signal and the second reference signal.

In an exemplary embodiment, the generation mode information is carried by the second communication node in the feedback information or other signaling except the feedback information;

or the generation mode information is acquired by the first communication node through a channel identification, and/or a time-frequency resource, and/or a scramble and/or a spreading codeword used by the second communication node for sending the feedback information.

In an exemplary embodiment, the first communication node sending the first reference signal and the second reference signal to the second communication node includes:

when sending the first reference signal to the second communication node, the first communication node sending the second reference signal to the second communication node; or after receiving a second reference signal sending request from the second communication node, sending the second reference signal to the second communication node; or after receiving a second reference signal sending request from a third communication node, the first communication node sending the second reference signal to the second communication node.

In an exemplary embodiment, the first reference signal is a beam reference signal realized based on a precoding technology, and the second reference signal is a non-beam reference signal sent by the first communication node to the second communication node by selecting X antenna ports from Y antenna ports, herein Y is a total number of antenna ports of the first communication node and X is less than or equal to Y;

or the first reference signal is a non-beam reference signal sent by the first communication node to the second communication node by selecting X antenna ports from Y antenna ports, and the second reference signal is a beam reference signal realized based on a precoding technology, herein Y is a total number of antenna ports of the first communication node and X is less than or equal to Y.

In an exemplary embodiment, a precoding vector used in the precoding technology is a row or column of a discrete Fourier transform matrix.

In an exemplary embodiment, the first reference signal is periodically or non-periodically sent and the second reference signal is periodically or non-periodically sent.

The embodiment of the present document further provides a method for receiving a reference signal, including:

a second communication node receiving a first reference signal and/or a second reference signal from a first communication node.

In an exemplary embodiment, if the second communication node successfully receives the first reference signal or receiving quality of the first reference signal is greater than or equal to a specific threshold, the second communication node receives or does not receive the second reference signal.

In an exemplary embodiment, if the second communication node does not successfully receive the first reference signal or the receiving quality of the first reference signal is less than the specific threshold, the second communication node receives the second reference signal, or the second communication node sends a second reference signal sending request to the first communication node, or the second communication node sends the second reference signal sending request to a third communication node.

In an exemplary embodiment, the method further includes:

the second communication node generating feedback information according to channel state information obtained based on the first reference signal and/or the second reference signal, and sending the generated feedback information to the first communication node.

In an exemplary embodiment, the method further includes: after the second communication node receives the second reference signal, the second communication node generating the feedback information according to channel state information obtained based on the second reference signal, and sending the generated feedback information to the first communication node.

In an exemplary embodiment, the method further includes:

the second communication node sending generation mode information corresponding to the feedback information to the first communication node, herein the generation mode information includes information about that the feedback information is generated based on the first reference signal, or is generated based on the second reference signal or is generated based on the first reference signal and the second reference signal.

In an exemplary embodiment, the generation mode information is carried by the second communication node in the feedback information or other signaling except the feedback information;

or the generation mode information is acquired by the first communication node through a channel identification, and/or a time-frequency resource, and/or a scramble and/or a spreading codeword used by the second communication node for sending the feedback information.

The embodiment of the present document further provides a communication node, including:

a sending module arranged to send a first reference signal and a second reference signal to a second communication node, herein the first reference signal is different from the second reference signal.

In an exemplary embodiment, the communication node further includes:

a receiving module arranged to receive feedback information from the second communication node; and

the sending module is further arranged to: send service data to the second communication node according to the received feedback information.

In an exemplary embodiment, the receiving module is further arranged to:

receive generation mode information of the feedback information from the second communication node; and

the communication node further includes: a determination module arranged to determine a mode for sending the service data to the second communication node according to the received generation mode information from the second communication node,

herein the generation mode information includes information about that the feedback information is generated based on the first reference signal, or is generated based on the second reference signal or is generated based on the first reference signal and the second reference signal.

The embodiment of the present document further provides a communication node, including:

a receiving module arranged to receive a first reference signal and/or a second reference signal from a first communication node.

In an exemplary embodiment, the receiving module is arranged to, if the first reference signal is successfully received or receiving quality is greater than or equal to a specific threshold, receive or not receive the second reference signal.

In an exemplary embodiment, the receiving module is further arranged to: if the first reference signal is not successfully received or the receiving quality is less than the specific threshold, receive the second reference signal; and

the communication node further includes: a sending module arranged to, when the receiving module does not successfully receive the first reference signal or the receiving quality is less than the specific threshold, send a second reference signal sending request to the first communication node or send the second reference signal sending request to a third communication node.

In an exemplary embodiment, the communication node further includes:

a generation module arranged to generate feedback information according to channel state information obtained based on the first reference signal and/or the second reference signal; and

the sending module is arranged to send the generated feedback information to the first communication node.

In an exemplary embodiment, the communication node further includes:

a generation module arranged to, after the receiving module receives the second reference signal, generate feedback information according to channel state information obtained based on the second reference signal; and

the sending module is arranged to send the generated feedback information to the first communication node.

In an exemplary embodiment, the communication node further includes a sending module arranged to; or the sending module is further arranged to:

send generation mode information corresponding to the feedback information to the first communication node, herein the generation mode information includes information about that the feedback information is generated based on the first reference signal, or is generated based on the second reference signal or is generated based on the first reference signal and the second reference signal.

The embodiment of the present document further provides a computer storage medium, in which computer-executable instructions are stored and used for executing any one of the methods.

As compared with the existing technology, the method provided by the embodiment of the present document includes: a first communication node sending a first reference signal and a second reference signal to a second communication node, the first reference signal is different from the second reference signal. By using the solution provided by the embodiment of the present document, the second communication node acquires channel state quality through the second reference signal which is different from the first reference signal when the second communication node cannot successfully receive the first reference signal.

### BRIEF DESCRIPTION OF DRAWINGS

FIG. 1 illustrates a flowchart of a method for sending a reference signal provided by an embodiment of the present document.

FIG. 2 illustrates a flowchart of a method for receiving a reference signal provided by an embodiment of the present document.

FIG. 3 illustrates a schematic diagram of structural components of a communication node provided by an embodiment of the present document.

FIG. 4 illustrates a schematic diagram of structural components of another communication node provided by an embodiment of the present document.

### DETAILED DESCRIPTION

The embodiments of the present document will be further described below with reference to the drawings and should not be used for limiting the protection scope of the present document.

Referring to FIG. 1, the embodiment of the present document provides a method for sending a reference signal, including the following step.

In step 100, a first communication node sends a first reference signal and a second reference signal to a second communication node, the first reference signal is different from the second reference signal.

Alternatively, in this step, the first communication node may be a base station and the second communication node may be a terminal.

Alternatively, in this step, when sending the first reference signal to the second communication node, the first communication node sends the second reference signal to the second communication node, or after receiving a second reference signal sending request from the second communication node, the first communication node sends the second reference signal to the second communication node, or after receiving a second reference signal sending request from a third communication node, the first communication node sends the second reference signal to the second communication node.

Alternatively, in this step, the situation that the first reference signal is different from the second reference signal may refer to that densities of the first reference signal and the second reference signal are different, or methods for generating the first reference signal and the second reference signal are different, or periods of the first reference signal and the second reference signal are different, or methods for restoring channel state information based on the first reference signal and the second reference signal are different, or different characteristics of channel state information are acquired according to the first reference signal and the second reference signal.

Alternatively, the first reference signal is a beam reference signal realized based on a precoding technology, and the second reference signal is a non-beam reference signal sent by the first communication node to the second communication node by selecting X antenna ports from Y antenna ports, herein Y is a total number of antenna ports of the first communication node and X is less than or equal to Y.

Or, the first reference signal is a non-beam reference signal sent by the first communication node to the second communication node by selecting X antenna ports from Y antenna ports, and the second reference signal is a beam reference signal realized based on a precoding technology, herein Y is a total number of antenna ports of the first communication node and X is less than or equal to Y.

Herein, a precoding vector used in the precoding technology is a row or column of a discrete Fourier transform matrix.

Alternatively, in this step, the first reference signal may be periodically or non-periodically sent and the second reference signal may be periodically or non-periodically sent.

Alternatively, the method for sending the reference signal provided by the embodiment of the present document further includes the following steps.

In step 101, the first communication node receives feedback information from the second communication node.

In this step, the feedback information carries channel state information.

In step 102, the first communication node sends service data to the second communication node according to the received feedback information.

In this step, the first communication node receives generation mode information of the feedback information from the second communication node, and determines a mode for sending the service data to the second communication node according to the received generation mode information. Herein, the first communication may use the determined mode to send the service data to the second communication node.

Herein, the generation mode information includes information about that the feedback information is generated based on the first reference signal, or is generated based on the second reference signal or is generated based on the first reference signal and the second reference signal.

Herein, the generation mode information of the feedback information is sent by the second communication node to the first communication node through an explicit or implicit mode. The explicit mode refers to that the second communication node carries the generation mode information in the feedback information or other signaling except the feedback information; and the implicit mode refers to that the first communication node acquires the generation mode information through a channel identification, and/or a time-frequency resource, and/or a scramble and/or a spreading codeword used by the second communication node for sending the feedback information.

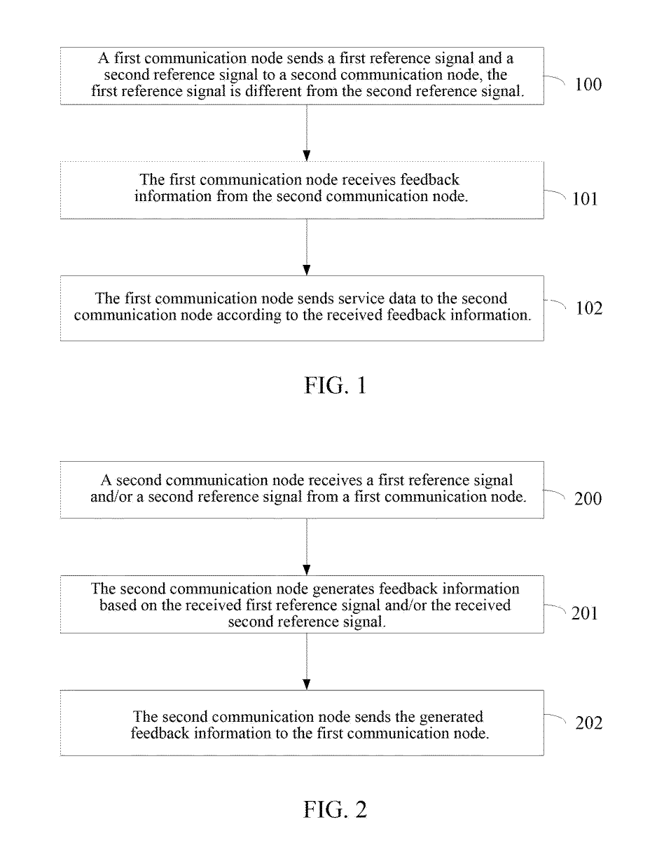

Referring to FIG. 2, the embodiment of the present document further provides a method for receiving a reference signal, including the following steps.

In step 200, a second communication node receives a first reference signal and/or a second reference signal from a first communication node.

In this step, if the second communication node successfully receives the first reference signal from the first communication node or receiving quality of the first reference signal is greater than or equal to a specific threshold, the second communication node may receive or not receive the second reference signal. Herein, the receiving quality may refer to signal strength, signal-to-noise ratio or the like.

If the second communication node does not successfully receive the first reference signal or the receiving quality of the first reference signal is less than the specific threshold, the second communication node receives the second reference signal, or the second communication node sends a second reference signal sending request to the first communication node, or the second communication node sends the second reference signal sending request to a third communication node.

Herein, the situation that the second communication node successfully receives or does not successfully receive the first reference signal from the first communication node refers to that the second communication node can or cannot effectively acquire channel state information according to the first reference signal.

The method for receiving the reference signal provided by the embodiment of the present document further includes the following steps.

In step 201, the second communication node generates feedback information based on the received first reference signal and/or the received second reference signal.

In this step, if the second communication node successfully receives the first reference signal from the first communication node or receiving quality of the first reference signal is greater than or equal to a specific threshold, the second communication node generates feedback information according to channel state information obtained based on the first reference signal and/or the second reference signal.

In this step, if the second communication node does not successfully receive the first reference signal or the receiving quality of the first reference signal is less than the specific threshold, the second communication node receives the second reference signal and generates feedback information according to channel state information obtained based on the second reference signal, or the second communication node sends a second reference signal sending request to the first communication node, or the second communication node sends the second reference signal sending request to a third communication node.

Herein, the specific threshold is configured by the second communication node itself, or is configured as defaulted by a standard, or is determined through negotiation between the first communication node and the second communication node.

In step 202, the second communication node sends the generated feedback information to the first communication node.

The method for receiving the reference signal provided by the embodiment of the present document further includes: the second communication node sends generation mode information corresponding to the feedback information to the first communication node through an explicit or implicit mode, herein the generation mode information includes information about that the feedback information is generated based on the first reference signal, or is generated based on the second reference signal or is generated based on the first reference signal and the second reference signal.

Herein, the explicit mode refers to that the second communication node carries the generation mode information in the feedback information or other signaling except the feedback information; and the implicit mode refers to that the first communication node acquires the generation mode information through a channel identification, and/or a time-frequency resource, and/or a scramble and/or a spreading codeword used by the second communication node for sending the feedback information.

The method provided by the embodiment of the present document will be described below in detail.

Embodiment 1: a base station sends a first reference signal and a second reference signal to a terminal.

The terminal receives the first reference signal. If the first reference signal is successfully received or receiving quality is greater than or equal to a specific threshold, the terminal generates feedback information according to channel state information obtained based on the first reference signal; and if the first reference signal is not successfully received or the receiving quality is less than the specific threshold, the terminal receives the second reference signal and generates feedback information according to channel state information obtained based on the second reference signal.

Herein, the specific threshold may be configured by the terminal itself, or may be configured as defaulted by a standard, or may be determined through negotiation between the base station and the terminal.

In embodiment 1, the base station may periodically send the first reference signal and the second reference signal to the terminal.

In embodiment 1, the base station may periodically send the first reference signal and the second reference signal to the terminal, and a sending period of the second reference signal is greater than a sending period of the first reference signal.

Embodiment 2: a base station sends a first reference signal and a second reference signal to a terminal.

The terminal receives the first reference signal. If the first reference signal is successfully received or receiving quality is greater than or equal to a specific threshold, the terminal generates feedback information according to channel state information obtained based on the first reference signal; and if the first reference signal is not successfully received or the receiving quality is less than the specific threshold, the terminal receives the second reference signal and generates feedback information according to channel state information obtained based on the second reference signal.

Herein, the specific threshold may be configured by the terminal itself, or may be configured as defaulted by a standard, or may be determined through negotiation between the base station and the terminal.

Herein, the feedback information further includes generation mode information, and the generation mode information describes whether the channel state information carried in the feedback information is generated based on the first reference signal or the second reference signal.

In embodiment 2, the base station may periodically send the first reference signal and the second reference signal to the terminal.

In embodiment 2, the base station may periodically send the first reference signal and the second reference signal to the terminal, and a sending period of the second reference signal is greater than a sending period of the first reference signal.

Embodiment 3: a base station sends a first reference signal and a second reference signal to a terminal.

The terminal receives the first reference signal. If the first reference signal is successfully received or receiving quality is greater than or equal to a specific threshold, the terminal generates feedback information according to channel state information obtained based on the first reference signal; and if the first reference signal is not successfully received or the receiving quality is less than the specific threshold, the terminal receives the second reference signal and generates feedback information according to channel state information obtained based on the second reference signal. Herein, the specific threshold may be configured by the terminal itself, or may be configured as defaulted by a standard, or may be determined through negotiation between the base station and the terminal.

Herein, generation mode information which describes whether the channel state information carried in the feedback information is generated based on the first reference signal or the second reference signal is notified by the terminal to the base station through other signaling except the feedback information, and is not included in the feedback information.

In embodiment 3, the base station may periodically send the first reference signal and the second reference signal to the terminal.

In embodiment 3, the base station may periodically send the first reference signal and the second reference signal to the terminal, and a sending period of the second reference signal is greater than a sending period of the first reference signal.

Embodiment 4: a base station sends a first reference signal and a second reference signal to a terminal.

The terminal receives the first reference signal. If the first reference signal is successfully received or receiving quality is greater than or equal to a specific threshold, the terminal generates feedback information according to channel state information obtained based on the first reference signal; and if the first reference signal is not successfully received or the receiving quality is less than the specific threshold, the terminal receives the second reference signal and generates feedback information according to channel state information obtained based on the second reference signal.

Herein, the specific threshold may be configured by the terminal itself, or may be configured as defaulted by a standard, or may be determined through negotiation between the base station and the terminal.

Herein, generation mode information which describes whether the channel state information carried in the feedback information is generated based on the first reference signal or the second reference signal is acquired by the base station through a channel identification, and/or a time-frequency resource, and/or a scramble and/or a spreading codeword used by the terminal for sending the feedback information.

In embodiment 4, the base station may periodically send the first reference signal and the second reference signal to the terminal.

In embodiment 4, the base station may periodically send the first reference signal and the second reference signal to the terminal, and a sending period of the second reference signal is greater than a sending period of the first reference signal.

Embodiment 5: a base station sends a first reference signal to a terminal.

The terminal receives the first reference signal. If the first reference signal is successfully received or receiving quality is greater than or equal to a specific threshold, the terminal generates feedback information according to channel state information obtained based on the first reference signal; and if the first reference signal is not successfully received or the receiving quality is less than the specific threshold, the terminal sends a second reference signal sending request to the base station. Herein, the specific threshold may be configured by the terminal itself, or may be configured as defaulted by a standard, or may be determined through negotiation between the base station and the terminal.

After the base station receives the second reference signal sending request, the base station sends a second reference signal to the terminal.

The terminal receives the second reference signal and generates feedback information according to channel state information obtained based on the second reference signal.

Embodiment 6: a base station periodically sends a first reference signal to a terminal.

The terminal receives the first reference signal. If the first reference signal is successfully received or receiving quality is greater than or equal to a specific threshold, the terminal generates feedback information according to channel state information obtained based on the first reference signal; and if the first reference signal is not successfully received or the receiving quality is less than the specific threshold, the terminal sends a second reference signal sending request to the base station. Herein, the specific threshold may be configured by the terminal itself, or may be configured as defaulted by a standard, or may be determined through negotiation between the base station and the terminal.

After the base station receives the second reference signal sending request, the base station periodically or instantly sends a second reference signal to the terminal.

The terminal receives the second reference signal and generates feedback information according to channel state information obtained based on the second reference signal.

Embodiment 7: a base station sends a first reference signal to a terminal.

The terminal receives the first reference signal. If the first reference signal is successfully received or receiving quality is greater than or equal to a specific threshold, the terminal generates feedback information according to channel state information obtained based on the first reference signal; and if the first reference signal is not successfully received or the receiving quality is less than the specific threshold, the terminal sends a second reference signal sending request to the base station. Herein, the specific threshold may be configured by the terminal itself, or may be configured as defaulted by a standard, or may be determined through negotiation between the base station and the terminal.

After the base station receives the second reference signal sending request, the base station sends a second reference signal to the terminal.

The terminal receives the second reference signal and generates feedback information according to channel state information obtained based on the second reference signal. Herein, the feedback information includes generation mode information, and the generation mode information describes whether the channel state information carried in the feedback information is generated based on the first reference signal or the second reference signal.

Embodiment 8: a base station sends a first reference signal to a terminal.

The terminal receives the first reference signal. If the first reference signal is successfully received or receiving quality is greater than or equal to a specific threshold, the terminal generates feedback information according to channel state information obtained based on the first reference signal; and if the first reference signal is not successfully received or the receiving quality is less than the specific threshold, the terminal sends a second reference signal sending request to the base station. Herein, the specific threshold may be configured by the terminal itself, or may be configured as defaulted by a standard, or may be determined through negotiation between the base station and the terminal.

After the base station receives the second reference signal sending request, the base station periodically or instantly sends a second reference signal to the terminal.

The terminal receives the second reference signal and generates feedback information according to channel state information obtained based on the second reference signal. Herein, the feedback information includes generation mode information, and the generation mode information describes whether the channel state information carried in the feedback information is generated based on the first reference signal or the second reference signal.

Embodiment 9: a base station sends a first reference signal to a terminal.

The terminal receives the first reference signal. If the first reference signal is successfully received or receiving quality is greater than or equal to a specific threshold, the terminal generates feedback information according to channel state information obtained based on the first reference signal; and if the first reference signal is not successfully received or the receiving quality is less than the specific threshold, the terminal sends a second reference signal sending request to the base station. Herein, the specific threshold may be configured by the terminal itself, or may be configured as defaulted by a standard, or may be determined through negotiation between the base station and the terminal.

After the base station receives the second reference signal sending request, the base station sends a second reference signal to the terminal.

The terminal receives the second reference signal and generates feedback information according to channel state information obtained based on the second reference signal. Herein, generation mode information which describes whether the channel state information carried in the feedback information is generated based on the first reference signal or the second reference signal is notified by the terminal to the base station through other signaling except the feedback information, and is not included in the feedback information.

Embodiment 10: a base station sends a first reference signal to a terminal.

The terminal receives the first reference signal. If the first reference signal is successfully received or receiving quality is greater than or equal to a specific threshold, the terminal generates feedback information according to channel state information obtained based on the first reference signal; and if the first reference signal is not successfully received or the receiving quality is less than the specific threshold, the terminal sends a second reference signal sending request to the base station. Herein, the specific threshold may be configured by the terminal itself, or may be configured as defaulted by a standard, or may be determined through negotiation between the base station and the terminal.

After the base station receives the second reference signal sending request, the base station periodically or instantly sends a second reference signal to the terminal.

The terminal receives the second reference signal and generates feedback information according to channel state information obtained based on the second reference signal. Herein, generation mode information which describes whether the channel state information carried in the feedback information is generated based on the first reference signal or the second reference signal is notified by the terminal to the base station through other signaling except the feedback information, and is not included in the feedback information.

In embodiment 9 or embodiment 10, the generation mode information may also be acquired by the base station through a channel identification, and/or a time-frequency resource, and/or a scramble and/or a spreading codeword used for sending the feedback information.

Embodiment 11: a base station sends a first reference signal and a second reference signal to a terminal.

The terminal receives the first reference signal and the second reference signal.

The terminal selects and sends feedback information generated based on the first reference signal and/or the second reference signal to the base station.

In embodiment 11, the base station may periodically send the first reference signal and the second reference signal to the terminal.

In embodiment 11, the base station may periodically send the first reference signal and the second reference signal to the terminal, and a sending period of the second reference signal is greater than a sending period of the first reference signal.

Embodiment 12: a base station sends a first reference signal and a second reference signal to a terminal.

The terminal receives the first reference signal and the second reference signal.

The terminal selects feedback information generated based on the first reference signal and/or the second reference signal and sends the generated feedback information to the base station. Herein, the feedback information includes generation mode information, and the generation mode information describes whether the channel state information carried in the feedback information is generated based on the first reference signal or the second reference signal.

In embodiment 12, the base station may periodically send the first reference signal and the second reference signal to the terminal.

In embodiment 12, the base station may periodically send the first reference signal and the second reference signal to the terminal, and a sending period of the second reference signal is greater than a sending period of the first reference signal.

Embodiment 13: a base station sends a first reference signal and a second reference signal to a terminal.

The terminal receives the first reference signal and the second reference signal.

The terminal selects feedback information generated based on the first reference signal and/or the second reference signal and sends the generated feedback information to the base station.

Generation mode information which describes whether the channel state information carried in the feedback information is generated based on the first reference signal or the second reference signal is notified by the terminal to the base station through other signaling except the feedback information, and is not included in the feedback information.

In embodiment 13, the base station may periodically send the first reference signal and the second reference signal to the terminal.

In embodiment 13, the base station may periodically send the first reference signal and the second reference signal to the terminal, and a sending period of the second reference signal is greater than a sending period of the first reference signal.

Embodiment 14: a base station sends a first reference signal and a second reference signal to a terminal.

The terminal receives the first reference signal and the second reference signal.

The terminal selects feedback information generated based on the first reference signal and/or the second reference signal and sends the generated feedback information to the base station.

Generation mode information which describes whether the channel state information carried in the feedback information is generated based on the first reference signal or the second reference signal is acquired by the base station through a channel identification, and/or a time-frequency resource, and/or a scramble and/or a spreading codeword used for sending the feedback information.

In embodiment 14, the base station may periodically send the first reference signal and the second reference signal to the terminal.

In embodiment 14, the base station may periodically send the first reference signal and the second reference signal to the terminal, and a sending period of the second reference signal is greater than a sending period of the first reference signal.

Embodiment 15: a base station sends a first reference signal to a terminal A.

The terminal A receives the first reference signal. If the first reference signal is successfully received or receiving quality is greater than or equal to a specific threshold, the terminal A generates feedback information according to channel state information obtained based on the first reference signal; and if the first reference signal is not successfully received or the receiving quality is less than the specific threshold, the terminal A sends a second reference signal sending request to a terminal B. Alternatively, the terminal B is located close to the terminal A and can successfully communicate with the base station. Herein, the specific threshold may be configured by the terminal itself, or may be configured as defaulted by a standard, or may be determined through negotiation between the base station and the terminal.

After the terminal B receives the second reference signal sending request from the terminal A, the terminal B sends a second reference signal sending request to the base station.

After the base station receives the second reference signal sending request from the terminal B, the base station sends a second reference signal to the terminal A.

The terminal A receives the second reference signal and generates feedback information according to channel state information obtained based on the second reference signal.

Embodiment 16: a base station periodically sends a first reference signal to a terminal A.

The terminal A receives the first reference signal. If the first reference signal is successfully received or receiving quality is greater than or equal to a specific threshold, the terminal A generates feedback information according to channel state information obtained based on the first reference signal; and if the first reference signal is not successfully received or the receiving quality is less than the specific threshold, the terminal A sends a second reference signal sending request to a terminal B. Alternatively, the terminal B is located close to the terminal A and can successfully communicate with the base station. Herein, the specific threshold may be configured by the terminal itself, or may be configured as defaulted by a standard, or may be determined through negotiation between the base station and the terminal.

After the terminal B receives the second reference signal sending request from the terminal A, the terminal B sends a second reference signal sending request to the base station.

After the base station receives the second reference signal sending request from the terminal B, the base station periodically sends a second reference signal to the terminal A.

The terminal A receives the second reference signal and generates feedback information according to channel state information obtained based on the second reference signal.

Embodiment 17: a base station periodically sends a first reference signal to a terminal A.

The terminal A receives the first reference signal. If the first reference signal is successfully received or receiving quality is greater than or equal to a specific threshold, the terminal A generates feedback information according to channel state information obtained based on the first reference signal; and if the first reference signal is not successfully received or the receiving quality is less than the specific threshold, the terminal A sends a second reference signal sending request to a terminal B. Alternatively, the terminal B is located close to the terminal A and can successfully communicate with the base station. Herein, the specific threshold may be configured by the terminal itself, or may be configured as defaulted by a standard, or may be determined through negotiation between the base station and the terminal.

After the terminal B receives the second reference signal sending request from the terminal A, the terminal B sends a second reference signal sending request to the base station.

After the base station receives the second reference signal sending request from the terminal B, the base station sends a second reference signal to the terminal A.

The terminal A receives the second reference signal and generates feedback information according to channel state information obtained based on the second reference signal.

Embodiment 18: a base station sends a first reference signal to a terminal A.

The terminal A receives the first reference signal. If the first reference signal is successfully received or receiving quality is greater than or equal to a specific threshold, the terminal A generates feedback information according to channel state information obtained based on the first reference signal; and if the first reference signal is not successfully received or the receiving quality is less than the specific threshold, the terminal A sends a second reference signal sending request to a terminal B. Alternatively, the terminal B is located close to the terminal A and can successfully communicate with the base station. Herein, the specific threshold may be configured by the terminal itself, or may be configured as defaulted by a standard, or may be determined through negotiation between the base station and the terminal.

After the terminal B receives the second reference signal sending request from the terminal A, the terminal B sends a second reference signal sending request to the base station.

After the base station receives the second reference signal sending request from the terminal B, the base station sends a second reference signal to the terminal A.

The terminal A receives the second reference signal and generates feedback information according to channel state information obtained based on the second reference signal. Herein, the feedback information includes generation mode information, and the generation mode information describes whether the channel state information carried in the feedback information is generated based on the first reference signal or the second reference signal.

Embodiment 19: a base station periodically sends a first reference signal to a terminal A.

The terminal A receives the first reference signal. If the first reference signal is successfully received or receiving quality is greater than or equal to a specific threshold, the terminal A generates feedback information according to channel state information obtained based on the first reference signal; and if the first reference signal is not successfully received or the receiving quality is less than the specific threshold, the terminal A sends a second reference signal sending request to a terminal B. Alternatively, the terminal B is located close to the terminal A and can successfully communicate with the base station. Herein, the specific threshold may be configured by the terminal itself, or may be configured as defaulted by a standard, or may be determined through negotiation between the base station and the terminal.

After the terminal B receives the second reference signal sending request from the terminal A, the terminal B sends a second reference signal sending request to the base station.

After the base station receives the second reference signal sending request from the terminal B, the base station periodically sends a second reference signal to the terminal A.

The terminal A receives the second reference signal and generates feedback information according to channel state information obtained based on the second reference signal. Herein, the feedback information includes generation mode information, and the generation mode information describes whether the channel state information carried in the feedback information is generated based on the first reference signal or the second reference signal.

Embodiment 20: a base station periodically sends a first reference signal to a terminal A.

The terminal A receives the first reference signal. If the first reference signal is successfully received or receiving quality is greater than or equal to a specific threshold, the terminal A generates feedback information according to channel state information obtained based on the first reference signal; and if the first reference signal is not successfully received or the receiving quality is less than the specific threshold, the terminal A sends a second reference signal sending request to a terminal B. Alternatively, the terminal B is located close to the terminal A and can successfully communicate with the base station. Herein, the specific threshold may be configured by the terminal itself, or may be configured as defaulted by a standard, or may be determined through negotiation between the base station and the terminal.

After the terminal B receives the second reference signal sending request from the terminal A, the terminal B sends a second reference signal sending request to the base station.

After the base station receives the second reference signal sending request from the terminal B, the base station sends a second reference signal to the terminal A.

The terminal A receives the second reference signal and generates feedback information according to channel state information obtained based on the second reference signal. Herein, the feedback information includes generation mode information, and the generation mode information describes whether the channel state information carried in the feedback information is generated based on the first reference signal or the second reference signal.

Embodiment 21: a base station sends a first reference signal to a terminal A.

The terminal A receives the first reference signal. If the first reference signal is successfully received or receiving quality is greater than or equal to a specific threshold, the terminal A generates feedback information according to channel state information obtained based on the first reference signal; and if the first reference signal is not successfully received or the receiving quality is less than the specific threshold, the terminal A sends a second reference signal sending request to a terminal B. Alternatively, the terminal B is located close to the terminal A and can successfully communicate with the base station. Herein, the specific threshold may be configured by the terminal itself, or may be configured as defaulted by a standard, or may be determined through negotiation between the base station and the terminal.

After the terminal B receives the second reference signal sending request from the terminal A, the terminal B sends a second reference signal sending request to the base station.

After the base station receives the second reference signal sending request from the terminal B, the base station sends a second reference signal to the terminal A.

The terminal A receives the second reference signal and generates feedback information according to channel state information obtained based on the second reference signal.

Generation mode information which describes whether the channel state information carried in the feedback information is generated based on the first reference signal or the second reference signal is notified by the terminal A to the base station through other signaling except the feedback information, and is not included in the feedback information.

Embodiment 22: a base station periodically sends a first reference signal to a terminal A.

The terminal A receives the first reference signal. If the first reference signal is successfully received or receiving quality is greater than or equal to a specific threshold, the terminal A generates feedback information according to channel state information obtained based on the first reference signal; and if the first reference signal is not successfully received or the receiving quality is less than the specific threshold, the terminal A sends a second reference signal sending request to a terminal B. Alternatively, the terminal B is located close to the terminal A and can successfully communicate with the base station. Herein, the specific threshold may be configured by the terminal itself, or may be configured as defaulted by a standard, or may be determined through negotiation between the base station and the terminal.

After the terminal B receives the second reference signal sending request from the terminal A, the terminal B sends a second reference signal sending request to the base station.

After the base station receives the second reference signal sending request from the terminal B, the base station periodically sends a second reference signal to the terminal A.

The terminal A receives the second reference signal and generates feedback information according to channel state information obtained based on the second reference signal.

Generation mode information which describes whether the channel state information carried in the feedback information is generated based on the first reference signal or the second reference signal is notified by the terminal A to the base station through other signaling except the feedback information, and is not included in the feedback information.

Embodiment 23: a base station periodically sends a first reference signal to a terminal A.

The terminal A receives the first reference signal. If the first reference signal is successfully received or receiving quality is greater than or equal to a specific threshold, the terminal A generates feedback information according to channel state information obtained based on the first reference signal; and if the first reference signal is not successfully received or the receiving quality is less than the specific threshold, the terminal A sends a second reference signal sending request to a terminal B. Alternatively, the terminal B is located close to the terminal A and can successfully communicate with the base station. Herein, the specific threshold may be configured by the terminal itself, or may be configured as defaulted by a standard, or may be determined through negotiation between the base station and the terminal.

After the terminal B receives the second reference signal sending request from the terminal A, the terminal B sends a second reference signal sending request to the base station.

After the base station receives the second reference signal sending request from the terminal B, the base station sends a second reference signal to the terminal A.

The terminal A receives the second reference signal and generates feedback information according to channel state information obtained based on the second reference signal.

Generation mode information which describes whether the channel state information carried in the feedback information is generated based on the first reference signal or the second reference signal is notified by the terminal A to the base station through other signaling except the feedback information, and is not included in the feedback information.

In embodiment 21, embodiment 22 or embodiment 23, the generation mode information which describes whether the channel state information carried in the feedback information is generated based on the first reference signal or the second reference signal may also be acquired by the base station through a channel identification, and/or a time-frequency resource, and/or a scramble and/or a spreading codeword used for the feedback information.

Embodiment 24: a terminal receives a first reference signal. If the first reference signal is successfully received or receiving quality is greater than or equal to a specific threshold, the terminal generates feedback information according to channel state information obtained based on the first reference signal; and if the first reference signal is not successfully received or the receiving quality is less than the specific threshold, the terminal receives a second reference signal and generates feedback information according to channel state information obtained based on the second reference signal. Herein, the specific threshold may be configured by the terminal itself, or may be configured as defaulted by a standard, or may be determined through negotiation between the base station and the terminal.

In embodiment 24, the feedback information may include generation mode information, and the generation mode information describes whether the channel state information carried in the feedback information is generated based on the first reference signal or the second reference signal.

In embodiment 24, the generation mode information which describes whether the channel state information carried in the feedback information is generated based on the first reference signal or the second reference signal may also be notified by the terminal to the base station through other signaling except the feedback information, and is not included in the feedback information.

In embodiment 24, the generation mode information which describes whether the channel state information carried in the feedback information is generated based on the first reference signal or the second reference signal may also be acquired by the base station through a channel identification, and/or a time-frequency resource, and/or a scramble and/or a spreading codeword used for the feedback information.

In embodiment 24, after the base station receives the generation mode information sent by the terminal, the base station determines a mode for sending service data to the terminal according to the generation mode information.

Embodiment 25: a terminal receives a first reference signal. If the first reference signal is successfully received or receiving quality is greater than or equal to a specific threshold, the terminal generates feedback information according to channel state information obtained based on the first reference signal; and if the first reference signal is not successfully received or the receiving quality is less than the specific threshold, the terminal sends a second reference signal sending request to the base station. Herein, the specific threshold may be configured by the terminal itself, or may be configured as defaulted by a standard, or may be determined through negotiation between the base station and the terminal.

After the base station receives the second reference signal sending request, the base station sends a second reference signal to the terminal.

The terminal receives a second reference signal and generates feedback information according to channel state information obtained based on the second reference signal.

In embodiment 25, the feedback information may include generation mode information, and the generation mode information describes whether the channel state information carried in the feedback information is generated based on the first reference signal or the second reference signal.

In embodiment 25, the generation mode information which describes whether the channel state information carried in the feedback information is generated based on the first reference signal or the second reference signal may also be notified by the terminal to the base station through other signaling except the feedback information, and is not included in the feedback information.

In embodiment 25, the generation mode information which describes whether the channel state information carried in the feedback information is generated based on the first reference signal or the second reference signal may also be acquired by the base station through a channel identification, and/or a time-frequency resource, and/or a scramble and/or a spreading codeword used for the feedback information.

In embodiment 25, after the base station receives the generation mode information sent by the terminal, the base station determines a mode for sending service data to the terminal according to the generation mode information.

Embodiment 26: a terminal receives a first reference signal and a second reference signal.

The terminal selects and sends feedback information generated based on the first reference signal and/or the second reference signal to a base station.

In embodiment 26, the feedback information may include generation mode information, and the generation mode information describes whether the channel state information carried in the feedback information is generated based on the first reference signal or the second reference signal.

In embodiment 26, the generation mode information which describes whether the channel state information carried in the feedback information is generated based on the first reference signal or the second reference signal may also be notified by the terminal to the base station through other signaling except the feedback information, and is not included in the feedback information.

In embodiment 26, the generation mode information which describes whether the channel state information carried in the feedback information is generated based on the first reference signal or the second reference signal may also be acquired by the base station through a channel identification, and/or a time-frequency resource, and/or a scramble and/or a spreading codeword used for the feedback information.

In embodiment 26, after the base station receives the generation mode information sent by the terminal, the base station determines a mode for sending service data to the terminal according to the generation mode information.

Embodiment 27: a terminal A receives a first reference signal. If the first reference signal is successfully received or receiving quality is greater than or equal to a specific threshold, the terminal A generates feedback information according to channel state information obtained based on the first reference signal; and if the first reference signal is not successfully received or the receiving quality is less than the specific threshold, the terminal A sends a second reference signal sending request to a terminal B. Alternatively, the terminal B is located close to the terminal A and can successfully communicate with the base station. Herein, the specific threshold may be configured by the terminal itself, or may be configured as defaulted by a standard, or may be determined through negotiation between the base station and the terminal.

After the terminal B receives the second reference signal sending request from the terminal A, the terminal B sends a second reference signal sending request to the base station.

After the base station receives the second reference signal sending request from the terminal B, the base station sends a second reference signal to the terminal A.

The terminal A receives the second reference signal and generates feedback information according to channel state information obtained based on the second reference signal.

In embodiment 27, the feedback information may include generation mode information, and the generation mode information describes whether the channel state information carried in the feedback information is generated based on the first reference signal or the second reference signal.

In embodiment 27, the generation mode information which describes whether the channel state information carried in the feedback information is generated based on the first reference signal or the second reference signal may also be notified by the terminal to the base station through other signaling except the feedback information, and is not included in the feedback information.

In embodiment 27, the generation mode information which describes whether the channel state information carried in the feedback information is generated based on the first reference signal or the second reference signal may also be acquired by the base station through a channel identification, and/or a time-frequency resource, and/or a scramble and/or a spreading codeword used for the feedback information.

In embodiment 27, after the base station receives the generation mode information sent by the terminal A, the base station determines a mode for sending service data to the terminal according to the generation mode information.

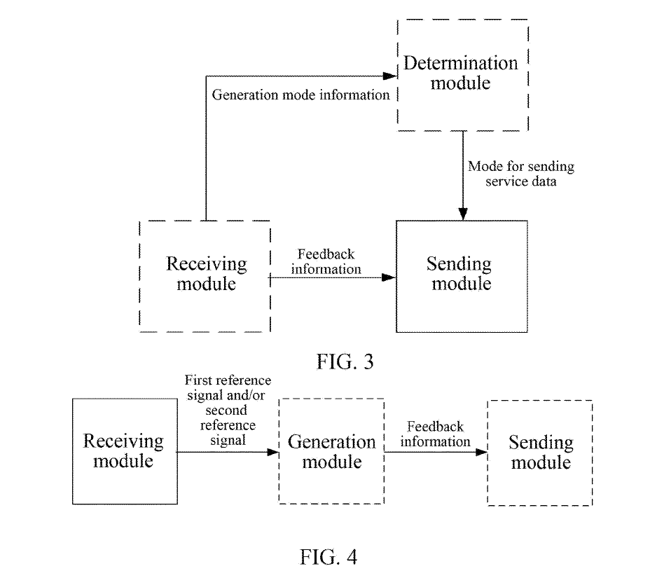

Referring to FIG. 3, the embodiment of the present document further provides a communication node, which at least includes:

a sending module arranged to send a first reference signal and a second reference signal to a second communication node, the first reference signal is different from the second reference signal.

The communication node provided by the embodiment of the present document further includes:

a receiving module arranged to receive feedback information from the second communication node; and

The sending module is further arranged to:

send service data to the second communication node according to the received feedback information.

In the communication node provided by the embodiment of the present document, the receiving module is further arranged to:

receive generation mode information from the second communication node.

The communication node further includes:

a determination module arranged to determine a mode for sending the service data to the second communication node according to the received generation mode information from the second communication node,

herein the generation mode information includes information about that the feedback information is generated based on the first reference signal, or is generated based on the second reference signal or is generated based on the first reference signal and the second reference signal.

Referring to FIG. 4, the embodiment of the present document further provides a communication node, which at least includes:

a receiving module arranged to receive a first reference signal and/or a second reference signal from a first communication node.

In the communication node provided by the embodiment of the present document, the receiving module is arranged to:

if the first reference signal is successfully received or receiving quality of the first reference signal is greater than or equal to a specific threshold, receive or not receive the second reference signal.

The communication node provided by the embodiment of the present document further includes:

a generation module arranged to generate feedback information according to channel state information obtained based on the first reference signal and/or the second reference signal; and

a sending module arranged to send the generated feedback information to the first communication node.

In the communication node provided by the embodiment of the present document, the receiving module is further arranged to:

if the first reference signal is not successfully received or the receiving quality of the first reference signal is less than the specific threshold, receive the second reference signal.

The sending module is further arranged to, when the receiving module does not successfully receive the first reference signal or the receiving quality of the first reference signal is less than the specific threshold, send a second reference signal sending request to the first communication node or send the second reference signal sending request to a third communication node.

The generation module is arranged to, after the receiving module receives the second reference signal, generate feedback information according to channel state information obtained based on the second reference signal.

In the communication node provided by the embodiment of the present document, the sending module is further arranged to:

send generation mode information corresponding to the feedback information to the first communication node, herein the generation mode information includes information about that the feedback information is generated based on the first reference signal, or is generated based on the second reference signal or is generated based on the first reference signal and the second reference signal.

It needs to be stated that the above-mentioned embodiments are just used for facilitating the understanding by one skilled in the art instead of limiting the protection scope of the present document, and any obvious replacements, improvements and the like made by one skilled in the art without departing from the concept of the present document should be all included in the protection scope of the present document.

One ordinary skilled in the art can understand that all or partial steps in the above-mentioned embodiments may be implemented by using a computer program flow, the program may be stored in a computer-readable storage medium, the computer program is executed on a corresponding hardware platform (e.g., a system, an apparatus, a device or a component), and one or a combination of the steps of the method embodiments is included during execution.

Optionally, all or partial steps in the above-mentioned embodiments may also be implemented by using integrated circuits; and these steps may be respectively manufactured into integrated circuit modules or a plurality of modules or steps thereof are manufactured into a single integrated circuit module to implement.

Each of the devices/function modules/function units in the above-mentioned embodiments may be implemented by using a general computing device, and they may be centralized in a single computing device and may also be distributed on a network consisting of a plurality of computing devices.

When each of the devices/function modules/function units in the above-mentioned embodiments is implemented by means of a software function module and is sold or used as an independent product, it may be stored in a computer-readable storage medium. The above-mentioned computer-readable storage medium may be a read-only memory, a magnetic disc, a compact disc or the like.

### INDUSTRIAL APPLICABILITY

The above-mentioned technical solution achieves the effect that the second communication node can still acquire the channel state quality when the second communication node cannot successfully receive the first reference signal from the first communication node.

What is claimed is:

1. A method for sending a reference signal, comprising:
a first communication node sending a first reference signal and a second reference signal to a second communication node, wherein the first reference signal is different from the second reference signal.

2. The method according to claim 1, wherein the method further comprises:
the first communication node receiving feedback information from the second communication node; and
the first communication node sending service data to the second communication node according to the received feedback information.

3. The method according to claim 2, wherein the first communication node sending the service data to the second communication node according to the received feedback information comprises:
the first communication node determining a mode for sending the service data to the second communication node according to generation mode information of the received feedback information from the second communication node,
wherein the generation mode information comprises information about that the feedback information is generated based on the first reference signal, or is generated based on the second reference signal or is generated based on the first reference signal and the second reference signal.

4. The method according to claim 3, wherein,
the generation mode information is carried by the second communication node in the feedback information or other signaling except the feedback information;
or the generation mode information is acquired by the first communication node through a channel identification, and/or a time-frequency resource, and/or a scramble and/or a spreading codeword used by the second communication node for sending the feedback information.

5. The method according to claim 1, wherein the first communication node sending the first reference signal and the second reference signal to the second communication node comprises:
when sending the first reference signal to the second communication node, the first communication node sending the second reference signal to the second communication node; or
after receiving a second reference signal sending request from the second communication node, sending the second reference signal to the second communication node; or after receiving a second reference signal sending request from a third communication node, the first communication node sending the second reference signal to the second communication node.

6. The method according to claim 1, wherein,
the first reference signal is a beam reference signal realized based on a precoding technology, and the second reference signal is a non-beam reference signal sent by the first communication node to the second communication node by selecting X antenna ports from Y antenna ports, wherein Y is a total number of antenna ports of the first communication node and X is less than or equal to Y;
or the first reference signal is a non-beam reference signal sent by the first communication node to the second communication node by selecting X antenna ports from Y antenna ports, and the second reference signal is a beam reference signal realized based on a precoding technology, wherein Y is a total number of antenna ports of the first communication node and X is less than or equal to Y,
and,
wherein, a precoding vector used in the precoding technology is a row or column of a discrete Fourier transform matrix.

7. (canceled)

8. The method according to claim 1, wherein,
the first reference signal is periodically or non-periodically sent and the second reference signal is periodically or non-periodically sent.

9. A method for receiving a reference signal, comprising:
a second communication node receiving a first reference signal and/or a second reference signal from a first communication node.

10. The method according to claim 9, wherein,
when the second communication node successfully receives the first reference signal or receiving quality of the first reference signal is greater than or equal to a specific threshold, the second communication node receives or does not receive the second reference signal,
and,
wherein,
when the second communication node does not successfully receive the first reference signal or the receiving quality of the first reference signal is less than the specific threshold, the second communication node receives the second reference signal, or the second communication node sends a second reference signal sending request to the first communication node, or the second communication node sends the second reference signal sending request to a third communication node.

11. (canceled)

12. The method according to claim 9, wherein the method further comprises:
the second communication node generating feedback information according to channel state information obtained based on the first reference signal and/or the second reference signal, and sending the generated feedback information to the first communication node,
or,
wherein the method further comprises:
after the second communication node receives the second reference signal, the second communication node generating the feedback information according to channel state information obtained based on the second reference signal, and sending the generated feedback information to the first communication node.

13. (canceled)

14. The method according to claim 9, wherein the method further comprises:
the second communication node sending generation mode information corresponding to the feedback information to the first communication node, wherein the generation mode information comprises information about that the feedback information is generated based on the first reference signal, or is generated based on the second reference signal or is generated based on the first reference signal and the second reference signal,
and,
wherein,
the generation mode information is carried by the second communication node in the feedback information or other signaling except the feedback information;
or the generation mode information is acquired by the first communication node through a channel identification, and/or a time-frequency resource, and/or a scramble and/or a spreading codeword used by the second communication node for sending the feedback information.

15. (canceled)

16. A communication node, comprising:
a sending module arranged to send a first reference signal and a second reference signal to a second communication node, wherein the first reference signal is different from the second reference signal.

17. The communication node according to claim 16, wherein the communication node further comprises:
a receiving module arranged to receive feedback information from the second communication node; and
the sending module is further arranged to send service data to the second communication node according to the received feedback information,
and,
wherein,
the receiving module is further arranged to receive generation mode information of the feedback information from the second communication node; and
the communication node further comprises:
a determination module arranged to determine a mode for sending the service data to the second communication node according to the received generation mode information from the second communication node,
wherein the generation mode information comprises information about that the feedback information is generated based on the first reference signal, or is generated based on the second reference signal or is generated based on the first reference signal and the second reference signal.

18. (canceled)

19. A communication node, comprising:
a receiving module arranged to receive a first reference signal and/or a second reference signal from a first communication node.

20. The communication node according to claim 19, wherein,
the receiving module is arranged to, when the first reference signal is successfully received or receiving quality is greater than or equal to a specific threshold, receive or not receive the second reference signal.

21. The communication node according to claim 20, wherein,
the receiving module is further arranged to, when the first reference signal is not successfully received or the receiving quality is less than the specific threshold, receive the second reference signal; and
the communication node further comprises:
a sending module arranged to, when the receiving module does not successfully receive the first reference signal or the receiving quality is less than the specific threshold, send a second reference signal sending request to the first communication node or send the second reference signal sending request to a third communication node, and
a generation module arranged to generate feedback information.

22. The communication node according to claim 19, wherein
the generation module is arranged to generate feedback information according to channel state information obtained based on the first reference signal and/or the second reference signal; and the sending module is arranged to send the generated feedback information to the first communication node,
or,
the generation module is arranged to, after the receiving module receives the second reference signal, generate feedback information according to channel state information obtained based on the second reference signal; and the sending module is arranged to send the generated feedback information to the first communication node.

23. (canceled)

24. The communication node according to claim 19, wherein the sending module is further arranged to:
send generation mode information corresponding to the feedback information to the first communication node, wherein the generation mode information comprises information about that the feedback information is generated based on the first reference signal, or is generated based on the second reference signal or is generated based on the first reference signal and the second reference signal.

25. A computer storage medium, in which computer-executable instructions are stored and used for executing the method according to claim 1.

26. A computer storage medium, in which computer-executable instructions are stored and used for executing the method according to claim 9.
